(19) United States
(12) Patent Application Publication
(10) Pub. No.: US 2009/0325814 A1
(43) Pub. Date: Dec. 31, 2009

(54) BIOMOLECULE DETECTION REAGENT AND METHOD FOR DETECTING BIOMOLECULE USING THE SAME

(75) Inventors: Hideki Hoshino, Tokyo (JP); Kazuyoshi Goan, Kanagawa (JP); Kazuya Tsukada, Kanagawa (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 12/441,520

(22) PCT Filed: Sep. 4, 2007
(86) PCT No.: PCT/JP2007/067182

§ 371 Date: Mar. 16, 2009

(30) Foreign Application Priority Data
Sep. 19, 2006 (JP) 2006252454

(51) Int. Cl. C40B 30/04; C40B 40/00

(52) U.S. Cl. 506/9; 506/13; 977/700; 977/920

(57) ABSTRACT

A biomolecule detection reagent comprising a semiconductor nanoparticle aggregate, wherein each semiconductor nanoparticle, constituting the semiconductor nanoparticle aggregate, has detection molecules binding specifically with biomolecules on its surface, and a standard deviation of numbers of the detection molecules existing on each semiconductor nanoparticle, is 5% or less.

### TECHNICAL FIELD

The present invention relates to a biomolecule detection reagent utilizing semiconductor nanoparticle aggregate, and a method for detecting a biomolecule using the reagent.

### BACKGROUND TECHNOLOGIES

The recent progress in nanotechnology suggests a possibility that nanoparticles can be used for detection, diagnosis, perception, and other uses. Further, recently, nanoparticle complexes, which interact with a biological system, receive broad attention in fields of biology and medicine. These complexes have been considered to be promising as a new intravascular probe for both perception (for example, imaging) and a therapeutic purpose (for example, drug delivery)

In general, a semiconductor material of nanometer size exhibiting a quantum confinement effect is called a “quantum dot”. Such a quantum dot is a tiny mass of a cluster of semiconductor atoms of from several hundred to several thousand with a size of within about a dozen or so nanometers, but when the quantum dot absorbs light from an excited source and reaches an energy excited state, it releases energy corresponding to an energy band gap of the quantum dot. Therefore, an energy band gap can be controlled by controlling the size or material composition of the quantum dot. As a result, energy in various wavelength bands can be utilized.

With advances of molecular biology, a variety of mechanisms in which biological body works has become clear, and efforts to elucidate a disease or a cancer of the brain or other organs at the molecular level have been made. As one of the efforts, a method for determining functions of the biological body and their abnormalities as fluorescence images, a so-called bio-imaging method, has been progressing. In this field, heretofore, a method of using a biosubstance labeling agent as a means for detecting a biomolecule, in which a molecule labeling substance was bonded to a marker substance, has been studied. However, marker substances such as organic fluorescence dyes, which had previously been used in the aforesaid method, exhibited disadvantages such as severe deterioration and short life upon exposure to ultraviolet rays and also resulted in lowered emission efficiency and insufficient sensitivity.

For that reason, a method employing a semiconductor nanoparticle as the above marker substance has been widely watched. For example, a biosubstance labeling agent, in which polymers exhibiting a polar functional group are absorbed or bonded physically and/or chemically to the surface of semiconductor nanoparticles, has been studied (for example, refer to Patent Document 3). Also a biosubstance labeling agent, in which organic molecules are bonded to the surface of Si/SiO₂ type semiconductor nanoparticles, has been studied (for example, refer to Patent Document 2).

For example, a technology is disclosed (for example Patent Document 3), in which biopolymers such as DNAs or proteins are readily detected utilizing semiconductor nanoparticles exhibiting different excited wavelengths and fluorescent emissions depending on different particle sizes.

However, in the above commonly known methods, a biosubstance labeling agent or a biomolecule detecting agent, to which from 1 to 1,000 detection molecules per semiconductor nanoparticle are bonded, are employed. Therefore, since one nanoparticle may be bonded to a plurality of antigens, decrease or variation of light emission signals may be caused, resulting in undesired results. Further, by operations of mixing and stirring in solution, the binding molecules did not uniformly attach to all nanoparticles, resulting in problems such as a large variation.

In recent years, a various detecting methods employing semiconductor nanoparticles have been developed, but no technologies, in which a semiconductor nanoparticle is allowed to react with a detection molecule on one-to-one, have been developed.

Patent Document 1: Unexamined Japanese Patent Application Publication No. (hereinafter, referred to as JP-A) 2003-329686

### Patent Document 2: JP-A 2005-172429

### Patent Document 3: JP-A 2003-322654

### DISCLOSURE OF THE INVENTION

### Issues to be Solved by the Invention

The present invention has been achieved in consideration of such problems, and it is an issue to be solved of the invention to provide a biomolecule detection reagent, in which biomolecule-detecting molecules exist uniformly on the surface of semiconductor nanoparticles, exhibiting less variance of fluorescence intensity and less reduction/variation in fluorescence intensity. Specifically, it is an issue to provide a biomolecule detection reagent, in which one detection molecule binding specifically with the biomolecule exists per semiconductor nanoparticle.

### Measures to Solve the Issues

The above issues of the present invention can be resolved by the measures below.

Item 1. A biomolecule detection reagent utilizing semiconductor nanoparticle aggregate, wherein each semiconductor nanoparticle, constituting the aforesaid semiconductor nanoparticle aggregate, has on its surface detection molecules which binds specifically with biomolecules, and the standard deviation of number of the aforesaid detection molecule, existing on each semiconductor nanoparticle, is 5% or less.

Item 2. The biomolecule detection reagent described in above Item 1, wherein one detection molecule, which binds specifically with the biomolecule, exists per above semiconductor nanoparticle.

Item 3. The biomolecule detection reagent described in above Item 1 or 2, wherein the above semiconductor nanoparticles can emit fluorescent light having different wavelengths depending on different particle sizes.

Item 4. The biomolecule detection reagent described in any one of above Items from 1 to 3, wherein the above detection molecule is avidin, streptavidin, or biotin.

Item 5. A method for detecting a biomolecule, wherein the biomolecule detection reagent described in any one of above Items from 1 to 4 is employed.

Item 6. The method for detecting the biomolecule described in above Item 5, wherein a semiconductor nanoparticle is allowed to bind to avidin or streptavidin, and a biomolecule labeled by biotin is detected via fluorescence emitted from the aforesaid semiconductor nanoparticle.

Item 7. The method for detecting a biomolecule described in above Items 5 or 6, wherein the method is carried out on a microarray.

### EFFECTS OF THE INVENTION

According to the above measures of the present invention, it is possible to provide a biomolecule detection reagent, in which biomolecule-detecting molecules exist uniformly on the surface of semiconductor nanoparticles, exhibiting less variance of fluorescence intensity and less reduction/variation in fluorescence intensity. Specifically, it is possible to provide a biomolecule detection reagent, in which one detection molecule, which binds specifically with the biomolecule, exists per semiconductor nanoparticle.

### DESCRIPTION OF THE PREFERRED EMBODIMENTS

The present invention and constitutional elements are described in detail below.

(Biomolecule Detection Reagent)

The biomolecule detection reagent of the present invention utilizing semiconductor nanoparticle aggregate is characterized in that each semiconductor nanoparticle, constituting the aforesaid semiconductor nanoparticle aggregate, has on its surface detection molecules which binds specifically with biomolecules, and standard deviation of number of the aforesaid detection molecule, existing on each semiconductor nanoparticle, is 5% or less. The above characteristics are commonly applicable to inventions of claims from 1 to 4.

The term “semiconductor nanoparticle aggregate” of the present invention indicates a solution incorporating semiconductor nanoparticles, a sheet in which semiconductor nanoparticles are dispersed, or a powder comprising semiconductor nanoparticles.

It is one of preferable embodiments to employ, as the biomolecule detection reagent of the present invention, a plurality of semiconductor nanoparticles which can emit fluorescent light having different wavelengths depending on different particle sizes. Even in such a case, it is required that the standard deviation of number of the aforesaid detecting molecule, existing on each semiconductor nanoparticle, is 5% or less.

Constitutional elements of the biomolecule detection reagent of the present invention are described in detail below.

(Semiconductor Nanoparticles)

The semiconductor nanoparticles constituting the biomolecule detection reagent of the present invention can be formed by employing various semiconductor materials. For example, semiconductor compounds of IV group, II-VI group, or III-V group of periodic table of elements can be employed.

Among II-VI group semiconductors, particularly listed are MgS MgSe, MgSe, MgTe, CaS, CaSe, CaTe, SrS, SrSe, SrTe, BaS, BaSe, BaTe, ZnS, ZnSe, ZnTe, CdS, CdSe, HgS, HgSe, and HgTe.

Among III-V group semiconductors, preferred are GaAs, GaN, GaP, GaSb, InGaAs, InU, InN, InSb, InAs, AlAs, AlP, AlSb, and AlS.

Among IV group semiconductors, Ge, Pb, and Si are particularly suitable.

In the present invention, the semiconductor nanoparticles may be formed as particles exhibiting a core/shell structure. In such a case, the so-called core/shell type semiconductor nanoparticle is a semiconductor nanoparticle exhibiting a core/shell structure which is constituted with a core particle comprising a semiconductor nanoparticle and a shell layer covering the aforesaid core particle, and chemical compositions of the aforesaid core particle and the aforesaid shell layer preferably differ from each other.

The core particle and the shell layer are described below.

<Core Particle>

Various semiconductor materials can be employed in the core particle. Specific examples thereof include MgS, MgSe, MgTe, CaS, CaSe, CaTe, SrS, SrSe, SrTe, BaS, BaTe, ZnS, ZnSe, ZaTe, CdS, CdSe, CdTe, GaAs, GaP, GaSb, InGaAs, InP, InN, SnSb, InAs, AlAs, AlP, AlSb, AlS, PbS, PbSe, Ge, Si, and a mixture of them. In the present invention, semiconductor material of Si is particularly preferred.

The semiconductor material may contain a very small amount of doping materials such as Ga, if necessary.

The average particle size of the core of the present invention is preferably from 1 to 10 nm to exhibits the effects of the invention. When the average particle size is made to be from 1 to 10 nm, labeling and detection of a biomolecule with a small particle size become possible. Further, when the size is made to be from 1 to 5 nm, labeling and dynamic imaging of one biomolecule become sufficiently possible. Therefore, the size of from 1 to 5 nm is particularly preferable.

The term “an average particle size” of the present invention denotes an accumulative 50% in volume particle size, which is determined via a laser scattering method.

<Shell Layer>

Various semiconductor materials can be employed for the shell layer. Specific examples include ZnO, ZnS, ZnSe, ZnTe, CdO, CdS, CdSe, CdTe, MgS, MgSe, GaS, CaN, GaP, GaAs, GaSh, InAs, InN, InP, InSb, AlAs, AlN, AlP, AlSb, and a mixture of them.

Preferable materials for the shell layer include semiconductor materials exhibiting higher band gap energy than that of the core of a semiconductor nanocrystal.

Materials suitable for the shell should have, in addition to higher band gap energy than that of a core of a semiconductor nanoparticle crystal, excellent conductivity and valence band offset regarding a core semiconductor nanocrystal. Therefore, it is desirable that the conduction band is higher than that of a core semiconductor nanocrystal, and the valence band is lower than that of a core semiconductor nanocrystal. For a core of semiconductor nanocrystal emitting energy in the visible region or in the near infrared region, materials having a band gap energy in the ultraviolet region are usable (for example, Si, Ge, and GaP for visible region, and InP, InN, PbS, and PbSe for infrared region). Specific examples thereof include ZnS, GaN and a magnesium chalcogenide (for example, MgS, MgSe, and MgTe).

For a core of a semiconductor nanocrystal emitting energy in the near infrared region, materials having band gap energy in the visible region are also usable.

In the present invention, semiconductor materials of SiO₂ and ZnS are particularly preferred.

The shell layer of the present invention does not necessarily perfectly cover the whole surface of the core particle, as long as the partially exposed core particle does not cause harmful effects.

<Method for Producing Semiconductor Nanocrystal>

Various commonly known methods can be employed for producing the semiconductor nanoparticles of the present invention.

The production method employing a liquid phase method includes a coprecipitation method as one of precipitation methods, a sol-gel method, a homogeneous precipitation method, and a reduction method. In addition, methods such as a reverse micelle method, and a supercritical hydrothermal synthesis method are also excellent methods for producing nanoparticles (for example, please refer to JP-A No. 2002-322468, JP-A No. 2005-239775, JP-A No. 10-310770, and JP-A No. 2000-104058).

As the production method of a gas phase method, the following methods are employed: (1) a method in which raw materials for manufacturing semiconductors are evaporated via the first high-temperature plasma generated between electrodes opposing each other, which are then passed through the second high-temperature plasma generated by electrodeless discharge in a reduced pressure atmosphere (for example, JP-A No. 6-279015), (2) a method in which, via electrochemical etching, nanoparticles are separated and removed from an anode composed of raw materials for semiconductors (for example, JP-A No. 2003-515459), and a laser abrasion method (for example, JP-A No. 2004-356163). Further, preferably employed is a method in which raw material gasses are subjected to a gas phase reaction in a reduced pressure state to synthesize powders containing particles.

As the method for producing the fluorescent semiconductor nanoparticles of the present invention, the production method via the liquid phase method is particularly preferred.

In order to achieve a uniform particle size and intensity of emitted light of the semiconductor nanoparticles of the present invention, the semiconductor nanoparticles exhibiting less lattice defects and high crystallinity are required by optimizing conditions such as a purity of the raw materials, concentration at synthesis, synthesis temperature time, and annealing temperature and time after the particles are formed.

<Surface Modification of Semiconductor Nanoparticles by Detection Molecule>

The surface of the semiconductor nanoparticle aggregate of the present invention is generally hydrophobic, so that the dispersibility of the particles in water is low to possibly cause problems such as coagulation of the particles if the particles are employed as they are. Therefore, it is preferable that the surface of nanoparticles (or the surface of shells, in case of the semiconductor nanoparticles being a core/shell type) is subjected to hydrophilic treatment.

The methods for hydrophilic treatment include, for example, a method in which a surface modification agent is chemically or physically bonded onto the surface of a particle after oleophilic groups on the surface are removed by pyridine. The surface modification agents, having a carboxyl group or an amino group as a hydrophilic group, are preferably employed, and the specific agents include a mercaptopropionic acid, a mercaptoundecanoic acid, and an aminopropanethiol.

The detection molecules of the present invention are not particularly limited, as long as they are employable for a specific detection of biopolymers, and examples thereof include oligonucleotides or polynucleotides such as avidin, or streptavidin, or biotin, an antigen, or an antibody, a DNA, or an RNA.

For example, in case where avidin or streptavidin is allowed to be bonded as a detection molecule, the bonds can be formed in such a manner that by employing an alkylthiol compound having a carboxyl group (hereinafter, also possibly referred to as a thiolcarboxylic acid) as, for example, a substituted alkylthiol, semiconductor nanoparticles with the above carboxyl groups being exposed on the surface, are prepared, and after the above carboxyl groups are further derivatized by employing, for example, N-hydroxysulfosuccinimide, avidin or streptavidin (available from, for example, Sigma-Aldrich Japan K.K.) are allowed to react with the derivatized carboxyl groups to form the bonds.

In case where biotins are allowed to be bonded as a detection molecule, the bonds can be formed in such a manner that, by employing alkylthiol compounds having amino groups (hereinafter, also possibly referred to as a aminothiol) as, for example, a substituted alkylthiol, semiconductor nanoparticles, with the above amino groups being exposed on the surface, are prepared, and the above amino groups are allowed to react with derivatized biotins such as Biotin-Sulfo-Osu (sulfosuccinimidyl D-biotin) (Dojin Laboratories) to form the bonds.

Any person skilled in the art can appropriately select reaction conditions and reagents suitable for bonding by substituted reactions, according to the kinds of functional groups on the semiconductor nanoparticles and the kinds of targeted detection molecules.

In the present invention, the detection molecules are preferably avidin, streptavidin, or biotin.

The biomolecule detection reagent of the present invention is characterized in that detection molecules, which specifically bind to biomolecules, exist on the surface of semiconductor nanoparticles. Further, it is characterized in that standard deviation of number of the aforesaid detection molecule existing on each semiconductor nanoparticle is 5% or less. The standard deviation employed above represents a degree of variation of number of detection molecule conjugated to a semiconductor nanoparticle, and is represented by a square root of the mean of the squared difference (a deviation) between number of detection molecules on each semiconductor and the mean number thereof-Further, it is particularly preferred that, as is described in Item 2 of the claim of the present invention, one detection molecule, which specifically binds to a biomolecule, exists on one of semiconductor nanoparticles.

To realize the above characteristics, various methods can be possible, but are not limited to. The surface modification can be carried out by reaction of a detection molecule on the surface of a semiconductor nanoparticle by methods such as, for example, a method in which one semiconductor nanoparticle is allowed to react with one detection molecule by employing microchannels such as MEMS (micro electro mechanical systems), or a method in which detection molecules are adsorbed on a surface layer of a nanoparticle after one layer of semiconductor nanoparticles nanoparticles is deposited on a substrate such as a porous alumina or a porous silica film.

(Method for Detecting Biomolecule)

Detection of a biomolecule such as a biopolymer by employing a biomolecule detection reagent of the present invention can be performed in such a manner that a biomolecule detection reagent of the present invention is added into a sample incorporating, for example, a polynucleotide or a protein, which are previously labeled with a molecule capable of specifically reacting with a detecting molecule, and the resulting semiconductor nanoparticles, on which specific bonding has been formed, are isolated, and then the fluorescence thereof is detected. The bonding reaction and the detection can also be performed in solution.

The detection may also be performed in a cell containing a biomolecule, and the reaction may also be performed on a microarray such as a DNA chip or a protein chip.

In an example of one embodiment of the present invention, for example, an oligonucleotide immobilized on a DNA chip is hybridized with a biotin-labeled oligonucleotide, after which the presence or absence of the hybridization can be detected by adding thereto the semiconductor nanoparticles bonded with avidin or streptavidin. Depending on the presence or absence of hybridization, it is possible to determine whether or not the targeted gene is present in an intended sample. The term “oligonucleotide” used in the present specification means, but not particularly limited to, a DNA or RNA oligonucleotide having a length of at most of 100 bases, and it may be of natural origin or may be synthesized.

Further, a cDNA immobilized on a DNA chip is hybridized with a biotin-labeled cDNA, after which the presence or absence of hybridization can be detected by adding semiconductor nanoparticles bonded with avidin or streptavidin thereto. Depending on the presence or absence of hybridization, it is possible to determine whether or not the targeted gene is present in an intended sample.

Moreover, an oligonucleotide immobilized on a DNA chip is hybridized with a biotin-labeled cDNA, after which the presence or absence of hybridization can be detected by adding semiconductor nanoparticles bonded with avidin or streptavidin thereto. Depending on the presence or absence of hybridization, it is possible to determine whether or not the targeted gene is present in an intended sample.

In other embodiment, an oligonucleotide immobilized on a DNA chip is hybridized with an avidin- or streptavidin-labeled oligonucleotide, after which the presence or absence of hybridization can be detected by adding semiconductor nanoparticles bonded with avidin thereto. As with the above case, depending on the presence or absence of hybridization, it is possible to determine whether or not the targeted gene is present in an intended sample.

Further, a cDNA immobilized on a DNA chip is hybridized with an avidin- or streptavidin-labeled cDNA, after which the presence or absence of hybridization can be detected by adding semiconductor nanoparticles bonded with biotin thereto. Depending on the presence or absence of hybridization, it is possible to determine whether or not the targeted gene is present in an intended sample.

Further, an oligonucleotide immobilized on a DNA chip is hybridized with an avidin- or streptavidin-labeled cDNA, after which the presence or absence of hybridization can be detected by adding semiconductor nanoparticles bonded with biotin thereto. Depending on the presence or absence of hybridization, it is possible to determine whether or not the targeted gene is present in an intended sample.

On the other hand, in a case of detecting a protein, for example, a protein immobilized on a protein chip is bonded to a biotin-labeled protein, after which the presence or absence of bonding between the proteins can be detected by adding semiconductor nanoparticles bonded to avidin or streptavidin thereto.

Further, a protein immobilized on a protein chip is bonded to a protein labeled with avidin or streptavidin, after which the presence or absence of bonding between the proteins can be detected by adding semiconductor nanoparticles bonded to biotin thereto.

As a method for detecting the biomolecule of the present invention, preferred is a method of an embodiment in which a semiconductor nanoparticle is bonded to avidin or streptavidin, and a biotin-labeled biomolecule is detected by fluorescence of the aforesaid semiconductor nanoparticle.

In the method of the present invention, a plurality of kinds of biopolymers can be detected by employing a plurality of kinds of semiconductor nanoparticles differing in particle size or chemical composition. If each peak of the fluorescence spectra of the semiconductor nanoparticles employed is distinguishable from each other, a plurality of kinds of biopolymers can be detected at the same time. Two peaks separated by, for example, about 100 nm from each other are sufficiently distinguishable, while depending on the sharpness of the peaks. The detectable range is from 400 nm to 700 nm.

### EXAMPLES

The present invention is described in detail below with reference to examples, but the invention is not limited to them.

Synthesis of Biomolecule Detection Reagent (Synthesis of Semiconductor Nanoparticle Being Surface-modified by Biotin)

### Comparative Example

Semiconductor nanoparticles were surface-modified by aminothiols. Amino groups of surface-modifying agents are modified by amino group labeling biotins.

S-2 (3 ethylaminopropylamino)ethyl dihydrogen phosphorothioate was charged into a suspension solution of core/shell type semiconductor nanoparticles of InGaP/zinc sulfide of 20 nm in diameter, which was then stirred for 24 hours under nitrogen gas atmosphere. After that, sulfosuccinimidyl D-biotin of an equal amount to amino group of a thiol compound was charged into the above reaction solution. After that, the resulting solution was stirred for one hour under nitrogen gas atmosphere to produce biotin-bonded semiconductor nanoparticles.

Employing a substance, in which one molecule of FITC (fluorescein isocyanate) was bonded to each biotin molecule which was conjugated to a semiconductor, emission intensity per biotin bonded semiconductor nanoparticle was detected employing a flow cytometer (manufactured by Beckman Coulter, Inc.). Preliminarily, a calibration graph between number of molecule of FITC and emission intensity was made. From the emission intensity thus obtained, number of FITC was obtained using the calibration curve, from which number of conjugated biotin for each semiconductor nanoparticle was obtained. The above results for 100 particles were obtained, from which the standard deviation of number of adsorbed biotin was calculated to be 6%.

### Example

S-2-(3-ethylaminopropylamino)ethyl dihydrogen phosphorothioate was charged into a suspension solution of core/shell type semiconductor nanoparticles of InGaP/zinc sulfide of 20 nm in diameter, which was then stirred for 24 hours under nitrogen gas atmosphere. After that sulfosuccinimidyl D-biotin of an equal amount to amino group of a thiol compound was charged into a porous silica film, which was stirred for one hour under nitrogen gas atmosphere. After that, unreacted substances were removed, and then washed to obtain semiconductor nanoparticles in which only one biotin is bonded to each particle. The above nanoparticles indicate the most preferable ones of the present invention, that is, the standard deviation of number of detection molecule is 0%.

A DNA (target), which is labeled utilizing an avidin/biotin system, is detected via a hybridization reaction (detection of DNA on a chip). Terminally-modified DNA by avidin is employed. The semiconductor nanoparticles are modified by biotin, which nanoparticles become a fluorescence label for DNA.

1. Extraction of mRNA

Solution D (guanidine thiocyanic acid, n-lauryl sarcosine, sodium citric acid of 1 M, and β-mercaptoethanol) was added to tissue sample in a ratio of 10 ml of solution D to one gram of tissue, which mixture was then homogenized. Then, into the resulting solution, each of sodium acetate (2M, pH4.0), acidic phenol, and chloroform was added while mixing, and then, stirred. The resulting solution was cooled on ice for 15 minutes, which was then subjected to a centrifuge separation at 15,000 rpm for 30 minutes. Into the separated water phase, isopropanol of an equal amount to the water phase was added, cooled at −20° C. for one hour, and then washed using 70% ethanol. The resulting solution was subjected to a centrifuge separation at 15,000 rpm for 15 minutes at 4° C. The separated solution was suspended again with 4 ml of DEPC-treated water, then into which 650 μl of 5M sodium chloride and 8 ml of CTAB/urea solution were added, and the resulting mixture was subjected to a centrifuge separation at 15,000 rpm for 15 minutes at room temperature. Into the separated solution, 8 ml of ethanol was added, and then cooled at −20° C. for one hour, followed by separation by a centrifugation at 15,000 rpm for 15 minutes at 4° C. The resulting separated solution was washed using 70% ethanol, and then suspended again with 4 ml of DEPC-treated water.

2. RT-PCR

Poly(A)-RNA, avidinylated oligo(dt) primer, and DEPC-treated water were mixed. The mixture was incubated at 70° C. for 10 minutes, and then rapidly cooled. Subsequently, into the above mixture, added were RNA sample/primer mixed solution, 10×PCR buffer, 25 mM MgCl₂, 10 mM dNTP mixture, 0.1 M DTT, and 1 μl of reverse transcriptase. The resulting mixture was then incubated at 42° C. for 50 minutes to terminate the reaction, after which, PCR was performed by adding 1 μl of RNaseH, and then subjected to incubation at 37° C. for 20 minutes to obtain avidinylated cDNA.

3. Hybridization

20×SSC, ion-exchanged water, and the above avidinylated cDNA were added into a tube, after which, the DNA was modified by incubation at 95° C. for 3 minutes, and then 10% SDS was added. The resulting hybridization solution was put on a DNA chip on a slide glass, on which a cover glass was placed, and was incubated at 65° C. for 20 hours to perform hybridization. After that, the above slide glass was immersed into a solution of 2×SSC 0.1% SDS to remove the cover glass. The resulting slide glass was washed repeatedly in SSC, subjected to a centrifuge separation at 1,000 rpm for 2 minutes, and then dried at room temperature.

4. Labeling by Semiconductor Nanoparticle

Semiconductor nanoparticles bonded with biotins were added to the DNA chips, which were subjected to hybridization reaction, and by allowing them to react, hybridized cDNA was labeled. Fluorescence intensity of each spot on the DNA chips was determined via a fluorescence scanner.

For each of semiconductor nanoparticles of Comparative example and Example, the standard deviation of fluorescence intensity (signal), calculated from data obtained by 100 repetitions of the above operations, was obtained.

The measured results indicated that the standard deviation of Comparative example was 8.6%, while the standard deviation of Example was 3.3%.

As the results clearly show, Example, in which a biomolecule detection reagent at the present invention was employed, exhibits, compared to Comparative example, less standard deviation of fluorescence intensity on each spot on a DNA chip, higher detection accuracy, and higher reproducibility. The reason for the above results is that, by taking the constitution of the present invention, biomolecule detection molecules uniformly bind to semiconductor nanoparticles of the biomolecule detection reagent of the present invention, to result in less variation in fluorescence intensity. Also it was found that, from a fluorescence intensity (an absolute value), substantially one detection molecule, which specifically binds to a biomolecule, exists on one semiconductor nanoparticle.

Further, in case of a biomolecule detection reagent, in which a plurality of semiconductor nanoparticles emitting fluorescent light having different wavelengths depending on difference in particle size, was employed, the similar results to the above were provided.

1. A biomolecule detection reagent comprising a semiconductor nanoparticle aggregate,
wherein each semiconductor nanoparticle, constituting the semiconductor nanoparticle aggregate, has detection molecules binding specifically with biomolecules on its surface, and a standard deviation of numbers of the detection molecules existing on each semiconductor nanoparticle, is 5% or less.

2. The biomolecule detection reagent described in claim 1,
wherein one detection molecule binding specifically with the biomolecule, exists per semiconductor nanoparticle.

3. The biomolecule detection reagent described in claim 1,
wherein the semiconductor nanoparticles can emit fluorescent light having different wavelengths depending on different particle sizes.

4. The biomolecule detection reagent described in claim 1,
wherein the detection molecule is avidin, streptavidin, or biotin.

5. A method for detecting a biomolecule comprising the step of:
employing the biomolecule detection reagent described in claim 1.

6. The method for detecting the biomolecule described in claim 5,
wherein a semiconductor nanoparticle is allowed to bind to avidin or streptavidin, and a biomolecule labeled by biotin is detected via fluorescence emitted from the semiconductor nanoparticle.

7. The method for detecting a biomolecule described in claim 5,
wherein the method is carried out on a microarray.
